(19) United States
(12) Patent Application Publication
(10) Pub. No.: US 2025/0256859 A1
(43) Pub. Date: Aug. 14, 2025

(54) ACOUSTICALLY TREATED THRUST REVERSER BULLNOSE FAIRING AND TORQUE BOX

(71) Applicant: The Boeing Company, Arlington, VA (US)

(72) Inventors: Alexandre CURAUDEAU, Mount Pleasant, SC (US); Justin Honshune LAN, Bothell, WA (US)

(73) Assignee: The Boeing Company, Arlington, VA (US)

(21) Appl. No.: 18/436,855

(22) Filed: Feb. 8, 2024

(51) Int. Cl. B64D 29/00; F02K 1/56; F02K 1/76; G10K 11/16

(52) U.S. Cl. CPC B64D 29/00; F02K 1/72; G10K 11/161

(57) ABSTRACT

An acoustically treated fairing assembly for a thrust reverser of an aircraft having a torque box fixed to the thrust reverser, a bullnose fairing attached to the torque box to form a cavity therebetween, and a plurality of spaced apart frame members extending axially within the cavity to divide the cavity into a plurality of circumferentially extending cavity sections configured to attenuate engine fan tones.

### FIELD

This disclosure relates to the attenuation of aircraft jet engine sound frequencies and, more particularly, to a bullnose fairing assembly for installation in an aircraft thrust reverser.

### BACKGROUND

Aircraft engine noise pollution is a significant concern, especially in high population areas and other noise-controlled environments. One source of aircraft engine noise pollution is engine fan tones which propagate through the thrust reverser. Attenuating these engine fan tones is desirable. Engine fan tone frequencies depend on the number of fan blades and rotation speed of the engine. The first few fan tone harmonics often have high amplitudes but are difficult to attenuate due to their low frequencies. Existing efforts to mitigate aircraft engine noise pollution do not satisfactorily address the concern, especially regarding fan tones with low frequencies.

It is desirable to provide a solution to mitigating engine fan tones that can be tuned to attenuate a desired frequency, including fan tone harmonics with low frequency.

### SUMMARY

According to various implementations, an acoustically treated bullnose fairing assembly for a thrust reverser of an aircraft is presented. The acoustically treated bullnose fairing assembly may include a torque box fixed to the thrust reverser of the aircraft, a bullnose fairing attached to the torque box to form a cavity therebetween, and a plurality of spaced apart frame members extending axially within the cavity to divide the cavity into a plurality of circumferentially extending cavity sections. In some implementations, each circumferentially extending cavity section may have a forward portion of the bullnose fairing and a rearward portion of the bullnose fairing associated therewith, with the rearward portion being aft of a forward edge of a blocker door of the thrust reverser when the blocker door is in a stowed position. In some implementations, the bullnose fairing associated with at least two of the circumferentially extending cavity sections have a perforated forward portion.

In some implementations, the perforated forward portion has an open area ratio in the range of 4 to 8 percent. In some implementations, the perforated forward portion has an open area ratio in the range of 10 to 20 percent.

In some implementations, the plurality of spaced apart frame members are spaced apart from each other in the range of 6 to 10 inches.

In some implementations, the acoustically treated bullnose fairing assembly includes a plurality of dividing members, each of the plurality of dividing members being configured to divide a corresponding one of the circumferentially extending cavity sections into a first and a second circumferentially extending cavity subsection.

In some implementations, each of the plurality of dividing members extends circumferentially across a portion of a corresponding one of the circumferentially extending cavity sections leaving an undivided portion between the first subsection and the second subsection of the corresponding one of the circumferentially extending cavity.

In some implementations, each of the plurality of dividing members extends axially across a portion of a corresponding one of the circumferentially extending cavity sections leaving an undivided portion between the first subsection and the second subsection of the corresponding one of the circumferentially extending cavity.

In some implementations, the first subsection has a first volume and the second subsection has a second volume that is different than the first volume.

In some implementations, the bullnose fairing associated with a first plurality of the circumferentially extending cavity sections includes perforated forward portions with a first percent open area and the bullnose fairing associated with a second plurality of the circumferentially extending cavity sections includes perforated forward portions with a second open area ratio greater than the first open area ratio. In some implementations, the first open area ratio is in the range of 4 to 8 percent and the second open area ratio is in the range of 10 to 20 percent.

In some implementations, the first plurality of the circumferentially extending cavity sections are circumferentially arranged in an alternating sequence with the second plurality of the circumferentially extending cavity sections.

In some implementations, the perforated forward portion includes a forward perforated section and a rearward unperforated section.

In some implementations, the perforated forward portion includes a lateral perforated section and a lateral unperforated section.

According to various implementations, a method of acoustically treating a bullnose fairing assembly for a thrust reverser of an aircraft is presented. In some implementations, the bullnose fairing assembly includes a bullnose fairing attached to a torque box to form a cavity therebetween. In some implementations, the method includes dividing the cavity into a plurality of circumferentially extending cavity sections and perforating the bullnose fairing associated with at least two of the plurality of circumferentially extending cavity sections in a forward portion of the front sheet that is forward of a forward edge a blocker door of the thrust reverser when the blocker door is in a stowed position.

In some implementation, perforating the front sheet includes creating an open area ratio in the forward portion in the range of 4 to 8%. In some implementation, perforating the front sheet further comprising creating an open area ratio in the forward portion in the range of 10 to 20%.

In some implementation, the method includes dividing at least one of the plurality of circumferentially extending cavity sections into a first subsection and a second subsection and leaving an undivided section between the first subsection and the second subsection.

In some implementation, dividing at least one of the plurality of circumferentially extending cavity sections into the forward subsection and the aft subsection includes perforating a dividing member that divides at least one of the plurality of circumferentially extending cavity sections.

In some implementation, perforating the forward portion associated with at least two of the plurality of circumferentially extending cavity sections includes creating a first open area ratio in the forward portion of a first of the plurality of circumferentially extending cavity sections and creating a second open area ratio in the forward portion of a second of the plurality of circumferentially extending cavity sections that is different than the first open area ratio.

In some implementation, the first of the plurality of circumferentially extending cavity sections is adjacent to the second of the plurality of circumferentially extending cavity sections.

In some implementations, one or more of the circumferentially extending cavity sections can be filled (fully or partially) with a noise attenuating materials (e.g., a honeycomb structure).

Combinations, (including multiple dependent combinations) of the above-described elements and those within the specification have been contemplated by the inventors and may be made, except where otherwise indicated or where contradictory.

### BRIEF DESCRIPTION OF THE DRAWINGS

Various features of the examples can be more fully appreciated, as the same become better understood with reference to the following detailed description of the examples when considered in connection with the accompanying figures, in which:

FIG. 1 is a side view illustrating a portion of an aircraft jet engine showing an example bullnose fairing assembly.

FIG. 2 is an enlarged side view illustrating the example bullnose fairing assembly of FIG. 1.

FIG. 3 is a perspective view of the example torque box of FIG. 1.

FIG. 4 is a perspective view of the example bullnose fairing attached to the torque box of FIG. 1.

FIG. 5 is a schematic representation of a portion an example implementation of the bullnose fairing assembly.

FIG. 6 is a schematic representation of a portion an example implementation of the bullnose fairing assembly.

FIG. 7 is a schematic representation of a portion an example implementation of the bullnose fairing assembly.

FIG. 8 is a schematic representation of a portion an example implementation of the bullnose fairing assembly.

FIG. 9 is a schematic representation of a portion an example implementation of the bullnose fairing assembly.

FIG. 10 is a schematic representation of a portion an example implementation of the bullnose fairing assembly.

FIG. 11 is a schematic representation of a portion an example implementation of the bullnose fairing assembly.

### DESCRIPTION OF THE EXAMPLES

Reference will now be made in detail to example implementations, illustrated in the accompanying drawings. Wherever convenient, the same reference numbers will be used throughout the drawings to refer to the same or like parts. In the following description, reference is made to the accompanying drawings that form a part thereof, and in which is shown by way of illustration specific exemplary examples in which the invention may be practiced. These examples are described in sufficient detail to enable those skilled in the art to practice the invention and it is to be understood that other examples may be utilized and that changes may be made without departing from the scope of the invention. The following description is, therefore, merely exemplary.

These and other features and advantages are shown and described herein in reference to the figures.

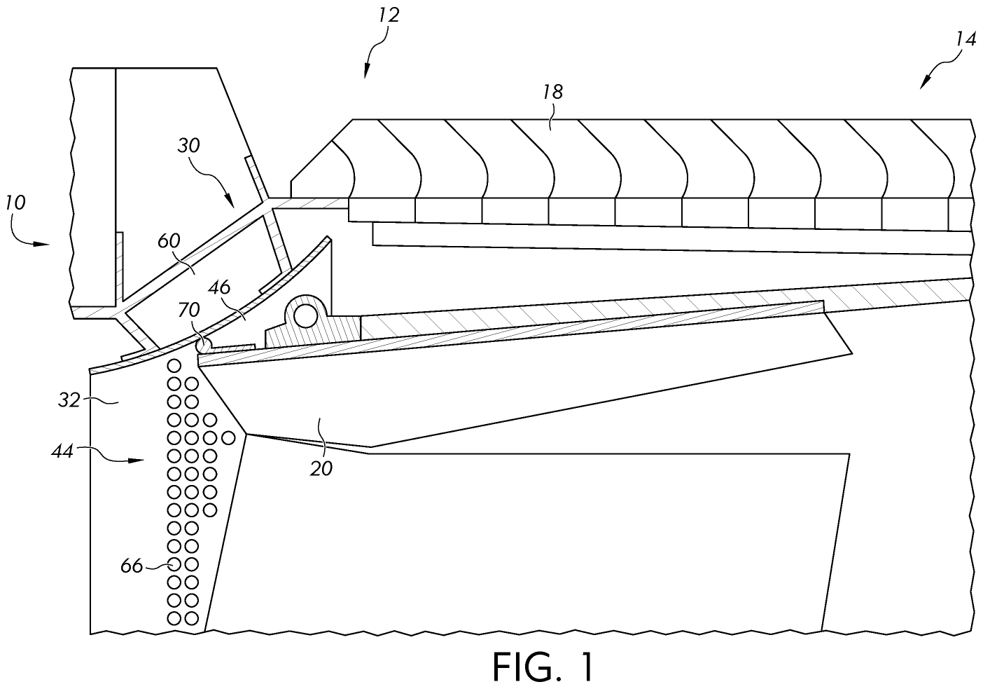

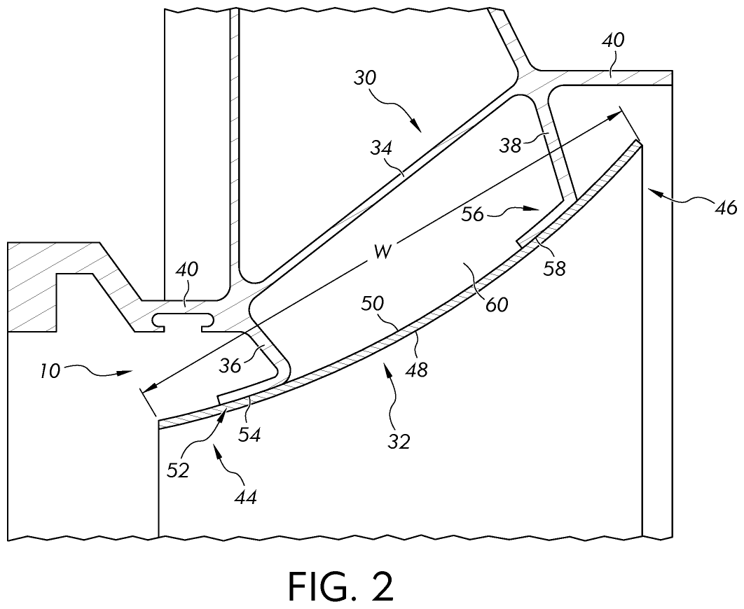

FIGS. 1-2 illustrate an example acoustically treated bullnose fairing assembly 10, according to the present disclosure. The bullnose fairing assembly 10 may be fixably attached to a thrust reverser 12 of an aircraft 14. The bullnose fairing assembly 10 may be fixably attached to the thrust reverser 12 by any suitable means (e.g., as is known in the art).

In the illustrated example, the thrust reverser 12 is positioned aft of a jet engine (not shown) on the aircraft and is fitted within the engine nacelle 16. The thrust reverser 12 includes thrust reverser cascades 18 circumferentially spaced around the interior of the engine nacelle 16. The thrust reverser cascades 18 are positioned aft and radially outward of the bullnose fairing assembly 10. The thrust reverser 12 also includes thrust reverser blocker doors 20 movable between a stowed position and a deployed or closed position. In other configurations, the thrust reverser cascades 18 may be stowed forward and radially out from the bullnose fairing assembly 10 and the thrust reverser cascades 18 translate aft with the rest of the thrust reverser 12 when the thrust reverser 12 is deployed.

During normal flying operations the thrust reverser cascades 18 are covered and the thrust reverser blocker doors 20 are in a stowed position (as shown in FIG. 1). For landing the aircraft, the thrust reverser cascades 18 are uncovered and the thrust reverser blocker doors 20 are moved to the deployed or closed position. This positioning routes engine high by-pass fan air along the bullnose fairing assembly 10 to flow through the thrust reverser cascades 18 to slow down the aircraft on the ground.

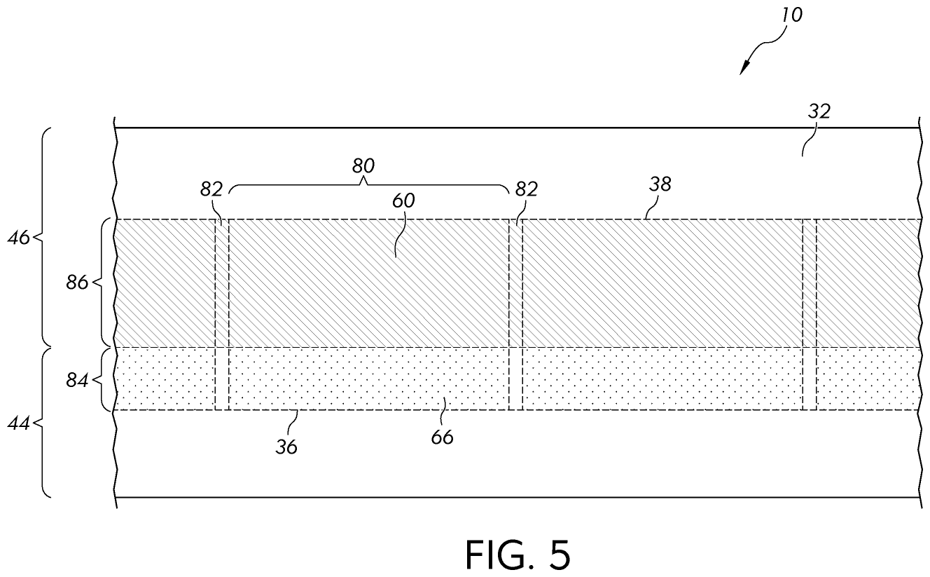

Referring to FIGS. 2-4, the acoustically treated bullnose fairing assembly 10 may be configured in a variety of ways. The bullnose fairing assembly 10 may extend circumferentially around the interior of the engine nacelle 16. In some implementations, the bullnose fairing assembly 10 includes a torque box 30 and a bullnose fairing 32. The torque box 30 may be configured in a variety of ways.

Referring to FIG. 2, in some implementations, the torque box 30 includes an outer wall 34, a forward side wall 36 extending radially inward from the outer wall 34, a rearward side wall 38 spaced apart from the forward side wall 36 and extending radially inward from the outer wall 34. The torque box 30 may include a plurality of attachment portions 40 configured to attach the torque box 30 to the thrust reverser cascades 18 (FIG. 1).

The bullnose fairing 32 is structurally configured to attach to the torque box 30. The bullnose fairing 32 may be configured in a variety of ways. In some implementations, the bullnose fairing 32 is formed as a sheet or plate having a width W, a forward portion 44, and a rearward portion 46. The bullnose fairing 32 may include first face 48 facing radially inward and a second face 50 facing radially outward opposite the first face 48. In some implementations, the first face 48 may be curved or convex. The bullnose fairing 32 can be made from a variety of materials. For example, in some implementations, the bullnose fairing 32 is made from extruded aluminum, sheet metal, composites, or the like.

As shown in FIG. 2, the bullnose fairing 32 may be attached to the forward side wall 36 and the rearward side wall 38 of the torque box 30. For example, in some implementations, the forward side wall 36 may include a first distal portion 52 having a first mounting portion 54 (e.g., flange, shoulder, collar, edge, etc.) structurally configured to attach to the second face 50 of the bullnose fairing 32. Likewise, the rearward side wall 38 may include a second distal portion 56 having a second mounting portion 58 (e.g., flange, shoulder, collar, edge, etc.) structurally configured to attach to the second face 50 of the bullnose fairing 32.

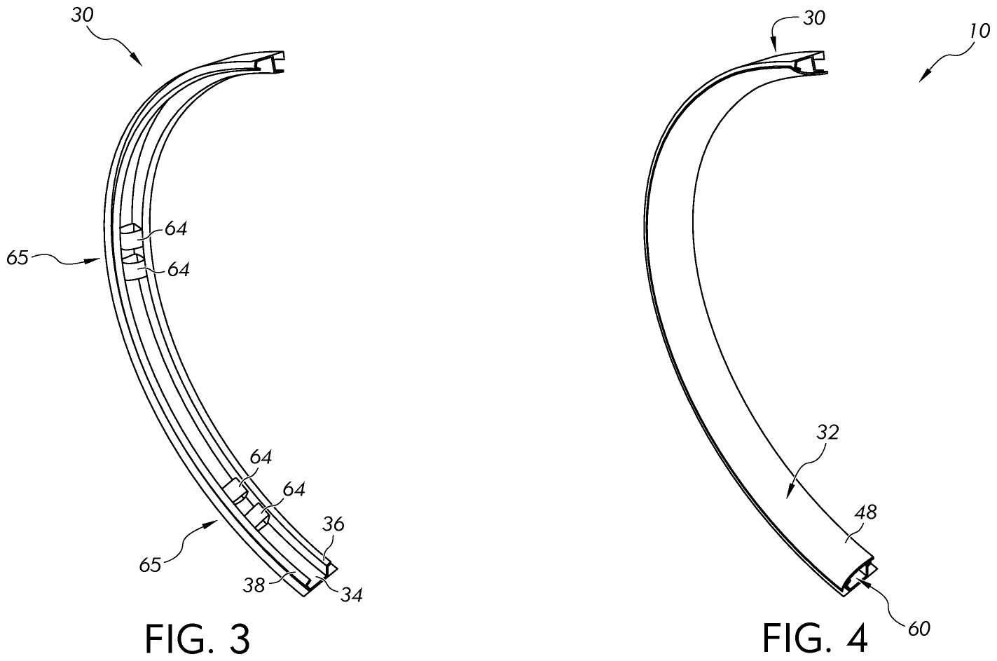

When connected to the torque box 30, the bullnose fairing 32, the outer wall 34, the forward side wall 36, and the rearward side wall 38 define a cavity or interior space 60 that extends circumferentially within the bullnose fairing assembly 10. The cavity 60 may be configured in a variety of ways, including different shapes (e.g., cross sectional shape) and sizes. As shown in FIG. 3, in some implementations, the bullnose fairing assembly 10 may include a plurality of spaced apart fittings 64 configured to provide structurally support for the bullnose fairing assembly 10. The fittings 64 may be configured in a variety of ways, including the shape, the size, the arrangement (e.g., the spacing between fittings), the number of fittings, etc. In the illustrated example, each fitting 64 is configured as a strip of material formed in a closed shape that generally follows the perimeter of the cavity shape (i.e., along or attached to the inner surface of the walls defining the cavity). In some implementations, the fittings 64 are arranged in pairs with each pair of fittings 65 spaced apart from each other circumferentially within the bullnose fairing assembly 10. In some implementations, the pairs of fittings 65 may be evenly spaced apart within the bullnose fairing assembly 10. In other implementations, however, the pairs of fittings 65 may be unevenly spaced apart within the bullnose fairing assembly 10.

The bullnose fairing assembly 10 can be configured to use the cavity 60 to attenuate engine fan tones from the engine which propagate through the thrust reverser 12. For example, the bullnose fairing 32 may include a plurality of perforations 66 that extend from the first face 48 through the bullnose fairing 32 and into the cavity 60, thereby forming open paths from the air flow through the thrust reverser 12 to the cavity 60. In this way, the cavity 60 can function as a Helmoltz resonator that can be configured to attenuate the engine fan tones.

For example, the number, the size, the location, and arrangement of the perforations 66 and the size and shape of the cavity 60 or sections of the cavity 60 can be selectively configured to attenuate specific engine fan tones. As shown in FIG. 1, when the thrust reverser blocker doors 20 are in the stowed position, the blocker doors 20 cover the rearward portion 46 of the bullnose fairing 32 (i.e., a portion of the bullnose fairing 32 that is aft of a forward edge 70 of the blocker doors 20 in the stowed position). The forward portion 44 of the bullnose fairing 32 (i.e., a portion forward of the forward edge 70 of the blocker doors 20) is not covered and is exposed to the airflow from the jet engine (not shown). In some implementations, the perforations 66 are formed in the forward portion 44. In some implementations, no perforations 66 are formed in the rearward portion 46.

The plurality of perforations 66 may be sized, shaped, and numbered as required to attenuate engine fan tones at desired frequencies. In particular, the plurality of perforations 66 may be configured to create a desired open area ratio (e.g., 10-20%, 4-8%, etc.) in the bullnose fairing 32. The plurality of perforations 66 can be configured to create any suitable open area ratio. Open area ratio is defined as the percentage open area relative to a base area. For example, the base area may be the area of the bullnose fairing 32 associated with (i.e., overlaps or covers) the cavity 60 and the open area ratio may be area of open space in the bullnose fairing 32 caused by the perforations 66 in the bullnose fairing 32, in the base area, divided by the base area. The individual size and shape of each perforation 66 may be selected as desired. In some implementations, each perforation 66 is generally a circular shape having a diameter in 0.02-0.08 inches, or approximately 0.05 inches. In other implementations, however, that diameter of each perforation 66 may be less than 0.02 inches or greater than 0.08 inches. Further, in some implementations, the perforations 66 may be shaped other than circular (e.g., oval, triangular, rectangular, or any other suitable shape).

In some implementations, the bullnose fairing assembly 10 may be configured to attenuate engine fan tones in different ways. For example, in some implementations, the bullnose fairing assembly 10 may be configured to act as a reactive acoustic structure (i.e., reflects acoustic energy). In other implementations, the bullnose fairing assembly 10 may be configured to act as a resistive acoustic structure (i.e., absorb acoustic energy). Further, in some implementations, some portions of bullnose fairing assembly 10 can be configured to act as a reflective acoustic structure while other portions of the bullnose fairing assembly 10 can be configured to act as a reactive acoustic structure. For example, configuring the bullnose fairing assembly 10 (or a portion thereof) to have a relatively low open area ratio (e.g., 4-8%) can cause the bullnose fairing assembly 10 to function as a resistive acoustic structure while configuring the bullnose fairing assembly 10 (or a portion thereof) to have a relatively high open area ratio (e.g., 10-20%) can cause the bullnose fairing assembly 10 to function as a reactive acoustic structure.

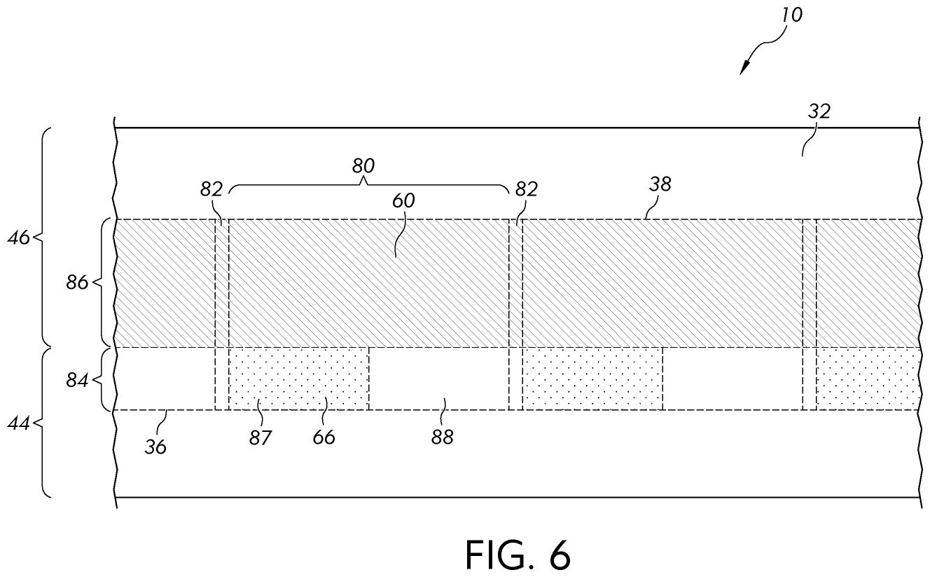

Referring to FIGS. 5-11, in some implementations, the circumferentially extending cavity 60 can be divided into a plurality of circumferentially extending cavity sections 80. For example, in some implementations, the bullnose fairing assembly 10 can include a plurality of spaced apart frame members 82. Each of the frame members 82 can be configured to extend axially within the cavity 60 to divide the cavity 60 into cavity sections 80. In some implementations, each cavity section 80 can individually attenuate engine fan tones and can be tuned to attenuate specific frequencies.

The frame members 82 may be configured in a variety of ways, including material, thickness, orientation, shape, spacing between frame members, etc. In some implementations, each frame member 82 forms a solid wall, or a wall with low porosity, that divides the cavity 60 into two adjacent circumferentially extending cavity sections 80. In some implementations, each frame member 82 extends axially across the entire cross-sectional shape of the cavity (i.e., extends from the bullnose fairing to the back wall and extends from the first wall to the second wall).

In some implementations, the cavity sections 80 may be equally sized to each other (e.g., the frame members 82 defining the cavity sections 80 may be evenly spaced apart). In other implementations, however, one or more cavity sections 80 may vary in size relative to one or more other cavity sections 80. The spacing of the frame members 82 may depend on the size of the engine and the desired frequencies for noise attenuation. In some implementations, the frame members 82 are spaced in the range of 6-10 inches apart.

In some implementations, each cavity section 80 may include a drainage path (not shown) to allow fluid to drain from each cavity sections 80 if fluid accumulates. In some implementations, the drainage path (not shown) may include one or more openings (e.g., perforations) formed in one or more of the frame members 82.

FIG. 5 is a partial schematic representation of an example implementation of the bullnose fairing assembly 10. The bullnose fairing assembly of FIG. 5 includes the frame members 82 (showed in dashed lines) that divide the cavity 60 (shown in dashed lines) into cavity sections 80. The bullnose fairing 32 may include a forward cavity portion 84 and a rearward cavity portion 86 (shown in crosshatch in FIG. 5). The forward cavity portion 84 is the portion of the forward portion 44 of the bullnose fairing 32 (i.e., the portion forward of the forward edge 70 of the blocker doors 20 when in the stowed position) that is positioned over the cavity 60. The rearward cavity portion 86 is the portion of the rearward portion 46 of the bullnose fairing 32 (i.e., the portion aft of the forward edge 70 of the blocker doors 20 when in the stowed position) that is positioned over the cavity 60.

As shown in FIG. 5, in some implementations, the bullnose fairing 32 includes the perforations 66 in the forward cavity portion 84. In the example of FIG. 5, the perforations 66 are shown evenly spaced across the entire forward cavity portion 84. In other implementations, however, the perforations 66 may be positioned only in a section of the forward cavity portion 84 and/or may be unevenly spaced or arranged in a pattern.

In some implementations, the bullnose fairing assembly 10 can be configured to perform as a reactive acoustic liner (i.e., reflects acoustic energy). For example, the number, size, and distribution of the perforations 66 are configured to create an open area ratio in the range 10-20%. An open area ratio in the range of 10-20% allows the bullnose fairing assembly 10 to reflect acoustic energy. For example, in some implementations, the bullnose fairing assembly 10 can reflect acoustic energy back toward the jet engine or toward other acoustic treatments.

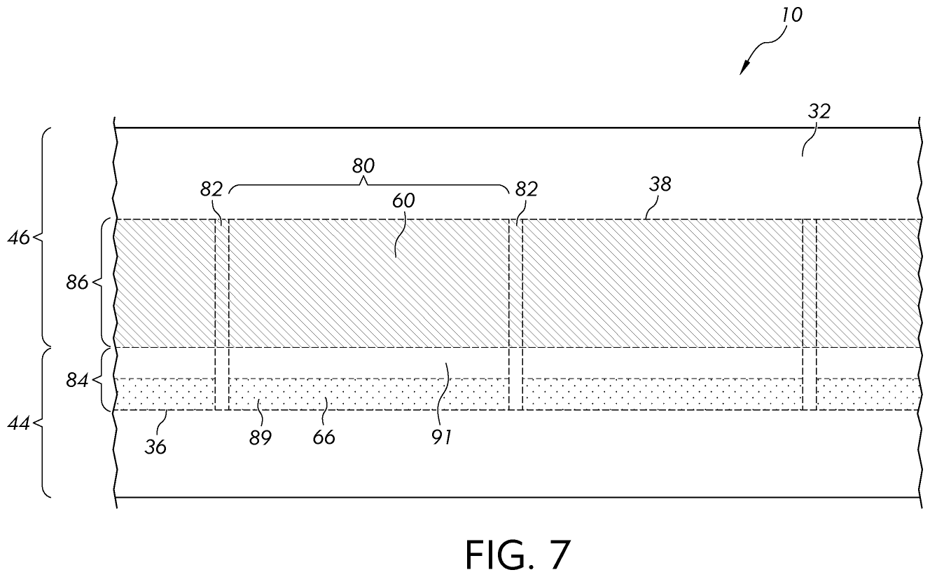

FIG. 6 is a partial schematic representation of an example implementation of the bullnose fairing assembly 10. The bullnose fairing assembly of FIG. 6 includes the frame members 82 (showed in dashed lines) that divide the cavity 60 (shown in dashed lines) into cavity sections 80. In some implementations, the bullnose fairing 32 includes the perforations 66 in the forward cavity portion 84. In the example of FIG. 6, the perforations 66 are shown evenly spaced across a portion (e.g., a circumferential half) of the forward cavity portion 84 such that forward cavity portion 84 includes a perforated lateral portion 87 and an unperforated lateral portion 88. In other implementations, however, the perforations 66 may be spread arranged in another portion of the forward cavity portion 84 or across the entire the forward cavity portion 84 and/or may be unevenly spaced or arranged in a pattern.

In some implementations, the bullnose fairing assembly 10 can be configured to perform as a resistive acoustic liner (i.e., absorbs acoustic energy). For example, the number, size, and distribution of the perforations 66 may be configured to create an open area ratio in the range 4-8%. An open area ratio in the range of 4-8% allows the bullnose fairing assembly 10 absorb acoustic energy. As compared to the example of FIG. 5, the bullnose fairing assembly of FIG. 6 may include less perforations.

FIG. 7 is a partial schematic representation of an example implementation of the bullnose fairing assembly 10. The bullnose fairing assembly of FIG. 7 includes the frame members 82 (showed in dashed lines) that divide the cavity 60 (shown in dashed lines) into cavity sections 80. In some implementations, the bullnose fairing 32 includes the perforations 66 in the forward cavity portion 84. In the example of FIG. 7, the perforations 66 are shown evenly spaced across a forward portion (e.g., axial forward half) of the forward cavity portion 84 to form a forward perforated portion 89 and a rearward unperforated portion 91. In other implementations, however, the perforations 66 may be spread arranged in another portion of the forward cavity portion 84 or across the entire the forward cavity portion 84 and/or may be unevenly spaced or arranged in a pattern.

In some implementations, the bullnose fairing assembly 10 can be configured to perform as a resistive acoustic liner (i.e., absorbs acoustic energy). For example, the number, size, and distribution of the perforations 66 may be configured to create an open area ratio in the range 4-8%. An open area ratio in the range of 4-8% allows the bullnose fairing assembly 10 absorb acoustic energy. As compared to the example of FIG. 5, the bullnose fairing assembly of FIG. 7 may include less perforations.

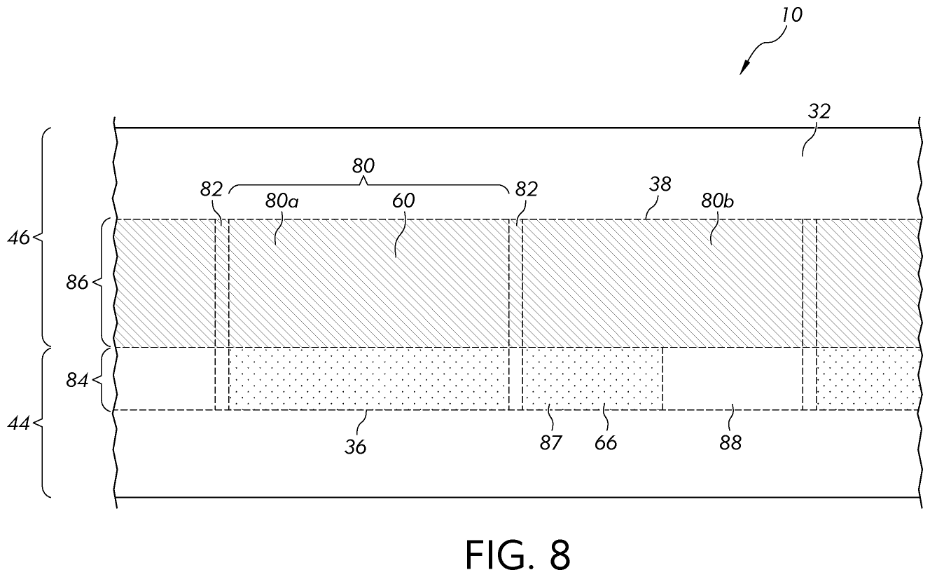

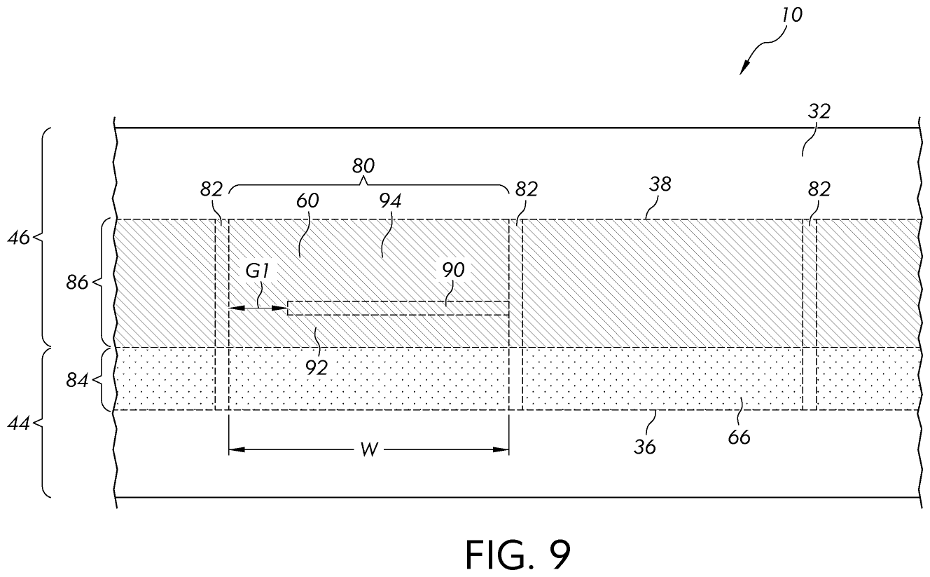

FIG. 8 is a partial schematic representation of an example implementation of the bullnose fairing assembly 10. The bullnose fairing assembly of FIG. 8 includes the frame members 82 (showed in dashed lines) that divide the cavity 60 (shown in dashed lines) into cavity sections 80. In some implementations, the bullnose fairing 32 includes the perforations 66 in the forward cavity portion 84. In some implementations, the amount and/or location of perforations 66 may vary in different cavity sections 80.

As shown in FIG. 8, in some implementations, the amount and/or location of perforations 66 in a first cavity section 80a may differ from the amount and location of perforations 66 in a second cavity section 80b. In the example of FIG. 8, the perforations 66 are shown evenly spaced across the entire forward cavity portion 84 of the first cavity section 80a while the perforations 66 are shown evenly spaced across a portion (e.g., a circumferential half) of the forward cavity portion 84 of the second cavity section 80b such that forward cavity portion 84 includes a perforated lateral portion 87 and an unperforated lateral portion 88.

In some implementations, the first cavity section 80a can be configured to perform as a reactive acoustic liner section (i.e., reflects acoustic energy). For example, the number, size, and distribution of the perforations 66 in the first cavity section 80a can be configured to create an open area ratio in the range 10-20%. An open area ratio in the range of 10-20% allows the first cavity section 80a of the bullnose fairing assembly 10 to reflect acoustic energy. In some implementations, the second cavity section 80b of the bullnose fairing assembly 10 can be configured to perform as a resistive acoustic liner (i.e., absorbs acoustic energy). For example, the number, size, and distribution of the perforations 66 in the section cavity section 80b may be configured to create an open area ratio in the range 4-8%. An open area ratio in the range of 4-8% allows the section cavity section 80b of the bullnose fairing assembly 10 to absorb acoustic energy.

FIG. 9 is a partial schematic representation of an example implementation of the bullnose fairing assembly 10. The bullnose fairing assembly of FIG. 9 includes the frame members 82 (showed in dashed lines) that divide the cavity 60 (shown in dashed lines) into cavity sections 80. In some implementations, the bullnose fairing 32 includes the perforations 66 in the forward cavity portion 84. In the example of FIG. 9, the perforations 66 are shown evenly spaced across the entire forward cavity portion 84. In other implementations, however, the perforations 66 may be positioned only in a section of the forward cavity portion 84 and/or may be unevenly spaced or arranged in a pattern.

In some implementations, the bullnose fairing assembly 10 can include a plurality of dividing members 90. Each of the plurality of dividing members 90 can be configured to extend circumferentially in one of the cavity sections 80 to divide the cavity sections 80 into a forward subsection 92 and an aft subsection 94. The dividing members 90 may be configured in a variety of ways, including material, thickness, orientation, shape, etc. In some implementations, each dividing member 90 extends partially across a width W of the cavity (e.g., extends between first and second frame members but leaves a gap G1 therebetween). In some implementations, the gap G1 is less than 10%, less than 20%, less than 30%, or less than 40% of the width W. Thus, the forward subsection 92 is open to the aft subsection 94.

The size of the forward subsection 92 relative to the aft subsection 94 may be vary in different implementations to tune the cavity section 80 as desired. In some implementations, the forward subsection 92 has the same volume as the aft subsection 94. In other implementations, the forward subsection 92 may be larger or smaller than the aft subsection 94.

In some implementations, the dividing member 90 may extend radially to connect the bullnose fairing 32 to the outer wall 34 (see FIG. 2). In other implementations, the dividing member 90 may only partially extend radially between the bullnose fairing 32 to the outer wall 34 such that a radially undivided portion (e.g., a gap) may be between the dividing member 90 and bullnose fairing 32 or may be between the dividing member 90 and outer wall 34. In some implementations, the dividing member 90 may extend fully between adjacent frame members 82 such that there is no gap G1. Instead, the dividing member 90 may have a radially undivided portion (e.g., a gap) between the dividing member 90 and bullnose fairing 32 or may have a radially undivided portion between the dividing member 90 and outer wall 34.

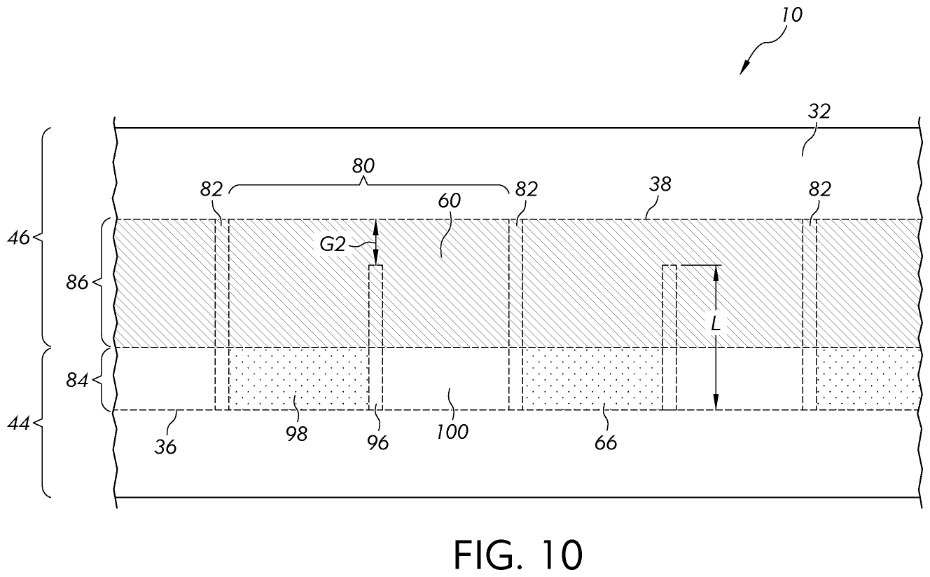

FIG. 10 is a partial schematic representation of an example implementation of the bullnose fairing assembly 10. The bullnose fairing assembly of FIG. 10 includes the frame members 82 (showed in dashed lines) that divide the cavity 60 (shown in dashed lines) into cavity sections 80. In some implementations, the bullnose fairing 32 includes the perforations 66 in the forward cavity portion 84. In the example of FIG. 10, the perforations 66 are shown evenly spaced across a portion (e.g., a circumferential half) of the forward cavity portion 84. In other implementations, however, the perforations 66 may be positioned only in a section of the forward cavity portion 84 and/or may be unevenly spaced or arranged in a pattern.

In some implementations, the bullnose fairing assembly 10 can include a plurality of dividing members 96. Each of the plurality of dividing members 96 can be configured to extend axially in one of the cavity sections 80 to divide the cavity sections 80 into a first lateral subsection 98 and a second lateral subsection 100. The dividing members 96 may be configured in a variety of ways, including material, thickness, orientation, shape, etc. In some implementations, each dividing member 96 extends partially across a length L of the cavity section 80 (e.g., extends between the forward side wall 36 and the rearward side wall 38 but leaves a gap G2 therebetween). In some implementations, the gap G2 is less than 10%, less than 20%, less than 30%, or less than 40% of the length L. Thus, the first lateral subsection 98 is open to the second lateral subsection 100.

The size of the first lateral subsection 98 relative to the second lateral subsection 100 may be vary in different implementations to tune the cavity section 80 as desired. In some implementations, the first lateral subsection 98 has the same volume as the second lateral subsection 100. In other implementations, the first lateral subsection 98 may be larger or smaller than the second lateral subsection 100.

In some implementations, the dividing member 96 may extend radially to connect the bullnose fairing 32 to the outer wall 34 (see FIG. 2). In other implementations, the dividing member 96 may only partially extend radially between the bullnose fairing 32 to the outer wall 34 such that a radially undivided portion (e.g., a gap) may be between the dividing member 96 and bullnose fairing 32 or may be between the dividing member 96 and outer wall 34. In some implementations, the dividing member 96 may extend fully between the forward side wall 36 and the rearward side wall 38 such that there is no gap G2. Instead, the dividing member 96 may have a radially undivided portion (e.g., a gap) between the dividing member 90 and bullnose fairing 32 or may have a radially undivided portion between the dividing member 90 and outer wall 34.

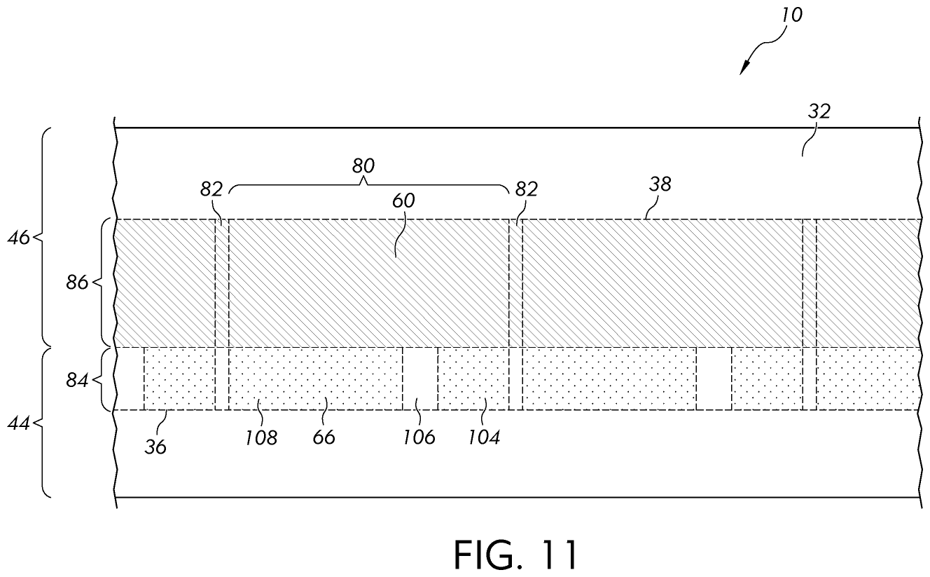

FIG. 11 is a partial schematic representation of an example implementation of the bullnose fairing assembly 10. The bullnose fairing assembly of FIG. 11 includes the frame members 82 (showed in dashed lines) that divide the cavity 60 (shown in dashed lines) into cavity sections 80. In some implementations, the bullnose fairing 32 includes the perforations 66 in the forward cavity portion 84. In some implementations, the forward cavity portion 84 may include two or more groups of perforations 66 separated by one or more unperforated portions. For example, in the illustrated implementation of FIG. 11, the perforations 66 are shown evenly spaced across a portion of the forward cavity portion 84 such that forward cavity portion 84 includes a first perforated portion 102, a second perforated portion 104, and an unperforated portion 106 dividing the first perforated portion 102 and the second perforated portion 104. In other implementations, however, the perforations 66 in the first perforated portion 102 and the second perforated portion 104 may be unevenly spaced or arranged in a pattern. Further, in other implementations, there may be more than two perforated portions separated by an unperforated portion(s).

In some implementations, the two or more perforated portions 102, 104 can be configured to create a desired open area ratio for a cavity section 80 and the bullnose fairing assembly 10 overall.

In some implementations, any of the circumferentially extending cavity sections, cavity subsections, or cavity portions, can be filled (fully or partially) with a noise attenuating materials. A variety of noise attenuating materials may be used. In some implementations, the noise attenuating material may be a honeycomb structure (not shown). For example, in some implementations, the honeycomb structure may have any commonly used honeycomb core designs such as flexcore, hexcore, or the like. In some implementations, the honeycomb structure may have cell sizes in the range % of an inch to % of an inch, or approximately % of an inch.

As used herein, the terms “A or B” and “A and/or B” are intended to encompass A, B, or {A and B}. Further, the terms “A, B, or C” and “A, B, and/or C” are intended to encompass single items, pairs of items, or all items, that is, all of: A, B, C, {A and B}, {A and C}, {B and C}, and {A and B and C}. The term “or” as used herein means “and/or.”

As used herein, language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

While the invention has been described with reference to the exemplary examples thereof, those skilled in the art will be able to make various modifications to the described examples without departing from the true spirit and scope. The terms and descriptions used herein are set forth by way of illustration only and are not meant as limitations. Although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. An acoustically treated fairing assembly for a thrust reverser of an aircraft, the thrust reverser having a stowable blocker door, the acoustically treated fairing assembly comprising:
a torque box fixed to the thrust reverser;
a bullnose fairing attached to the torque box to form a cavity therebetween; and
a plurality of spaced apart frame members extending axially within the cavity to divide the cavity into a plurality of circumferentially extending cavity sections, each circumferentially extending cavity section having a forward portion of the bullnose fairing and a rearward portion of the bullnose fairing associated therewith, the rearward portion being aft of a forward edge of the stowable blocker door when the stowable blocker door is in a stowed position,
wherein the bullnose fairing associated with at least two of the circumferentially extending cavity sections has a perforated forward cavity portion.

2. The acoustically treated fairing assembly according to claim 1, wherein the perforated forward cavity portion has an open area ratio in a range of 4 to 8 percent.

3. The acoustically treated fairing assembly according to claim 1, wherein the perforated forward cavity portion has an open area ratio in a range of 10 to 20 percent.

4. The acoustically treated fairing assembly according to claim 1, wherein the plurality of spaced apart frame members are spaced apart from each other in a range of 6-10 inches.

5. The acoustically treated fairing assembly according to claim 1, further comprising a plurality of dividing members, each of the plurality of dividing members being configured to divide a corresponding one of the circumferentially extending cavity sections into a first subsection and a second subsection.

6. The acoustically treated fairing assembly according to claim 5, wherein each of the plurality of dividing members partially extends circumferentially across a corresponding one of the circumferentially extending cavity sections leaving an undivided portion between the first subsection and the second subsection.

7. The acoustically treated fairing assembly according to claim 5, wherein each of the plurality of dividing members partially extends axially across a corresponding one of the circumferentially extending cavity sections leaving an undivided portion between the first subsection and the second subsection.

8. The acoustically treated fairing assembly according to claim 5, wherein the first subsection has a first volume and the second subsection has a second volume that is different than the first volume.

9. The acoustically treated fairing assembly according to claim 1, wherein the bullnose fairing associated with a first plurality of the circumferentially extending cavity sections includes perforated forward portions with a first open area ratio and the bullnose fairing associated with a second plurality of the circumferentially extending cavity sections includes perforated forward cavity portions with a second open area ratio greater than the first open area ratio.

10. The acoustically treated fairing assembly according to claim 9, wherein the first open area ratio is in a range of 4 to 8 percent and the second open area ratio is in a range of 10 to 20 percent.

11. The acoustically treated fairing assembly according to claim 9, wherein the first plurality of the circumferentially extending cavity sections are circumferentially arranged in an alternating sequence with the second plurality of the circumferentially extending cavity sections.

12. The acoustically treated fairing assembly according to claim 1, wherein the perforated forward portion includes a forward perforated section and a rearward unperforated section.

13. The acoustically treated fairing assembly according to claim 1, wherein the perforated forward portion includes a lateral perforated section and a lateral unperforated section.

14. A method of acoustically treating a fairing assembly for a thrust reverser of an aircraft, the thrust reverser having a stowable blocker door, the fairing assembly having a bullnose fairing attached to a torque box to form a cavity therebetween, the method comprising:
dividing the cavity into a plurality of circumferentially extending cavity sections; and
perforating the bullnose fairing associated with at least two of the plurality of circumferentially extending cavity sections in a forward cavity portion of the bullnose fairing that is forward of a forward edge of the stowable blocker door when the stowable blocker door is in a stowed position.

15. The method according to claim 14, wherein perforating the bullnose fairing further comprising creating an open area ratio in the forward cavity portion in a range of 4 to 8%.

16. The method according to claim 14, wherein perforating the bullnose fairing further comprising creating an open area ratio in the forward cavity portion in a range of 10 to 20%.

17. The method according to claim 14, further comprising dividing at least one of the plurality of circumferentially extending cavity sections into a first subsection and a second subsection and leaving an undivided section between the first subsection and the second subsection.

18. The method according to claim 17, wherein dividing at least one of the plurality of circumferentially extending cavity sections into the first subsection and the second subsection further comprises perforating a dividing member that divides the at least one of the plurality of circumferentially extending cavity sections.

19. The method according to claim 14, wherein perforating the forward cavity portion associated with at least two of the plurality of circumferentially extending cavity sections further comprising creating a first open area ratio in the forward cavity portion associated with a first of the plurality of circumferentially extending cavity sections and creating a second open area ratio in the forward cavity portion associated with a second of the plurality of circumferentially extending cavity sections that is different than the first open area ratio.

20. The method according to claim 19, wherein the first of the plurality of circumferentially extending cavity sections is adjacent the second of the plurality of circumferentially extending cavity sections.
